(19) United States
(12) Patent Application Publication
(10) Pub. No.: US 2009/0180160 A1
(43) Pub. Date: Jul. 16, 2009

(54) OPTICAL IMAGING WITH OPTIMIZED ILLUMINATION EFFICIENCY AND UNIFORMITY

(76) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/972,116

(22) Filed: Jan. 10, 2008

(51) Int. Cl. H04N 1/04

(52) U.S. Cl. 358/475

(57) ABSTRACT

A method for uniformly illuminating a predetermined scan line position on a media sheet containing an image includes defining an optical path from a media sheet to a sensor, selecting a predetermined scan line position on the media sheet, and emitting a light beam from a light source whereby a portion of the light beam illuminates a first portion of the predetermined scan line and a portion of the light beam is reflected from a reflector to illuminate a second, opposed portion of the predetermined scan line position. A method for imaging a scan line on a media sheet includes these steps and also collecting at least a portion of the light beam reflected from or transmitted through the media sheet to image the portion of the media sheet defined by the predetermined scan line position. Still further, an optical imaging module is provided for accomplishing the described method.

### FIELD OF THE INVENTION

A method for uniformly and efficiently illuminating a scan line position on a media sheet to be imaged is provided. In a representative embodiment the method comprises emitting a light beam from a diffuse light source to illuminate a first portion of the scan line position, and reflecting a portion of the light beam from a reflector to illuminate a second, opposed portion of the scan line position. Further, an optical imaging module for use in electrophotographic devices such as printers, multi-function printers (MFP's), all-in-one printers, copy machines, scanners, and the like is provided, for uniformly and efficiently illuminating a scan line position on a media sheet in accordance with the method.

### BACKGROUND OF THE INVENTION

Electrophotographic devices such as printers, scanners, copy machines, and the like typically include a variety of components, including at least a scanning unit for imaging a document to be copied or scanned. Such scanning units typically include an optical imaging module, including at least a light source for illuminating a portion of the document being scanned or copied and a photoreceptor sensor array for capturing an image or portion of an image from the document and converting that image to an electrical signal for further processing. Examples of such sensor arrays include charge-coupled devices, complementary metal oxide semiconductor sensors array, photodiode arrays, and the like.

During a scanning or copying operation, typically a media sheet containing one or more images to be scanned or copied is divided into multiple scan line positions. The portion of the image contained in a particular scan line position is imaged by photoreceptors contained in the sensor array. As an example, for color imaging, one embodiment of a charge-coupled device typically includes photoreceptors capable of detecting light in wavelengths corresponding to at least red, blue, and green. Each color sensor line provides the corresponding color channel. A typical color sensor array includes at least red, green and blue channels. For high throughput performance need in the often selected monochromatic imaging mode, a separate monochromatic channel can be included. The addition of the monochromatic channel increases the overall sensor chip width and therefore demands a wider uniformly illuminated band on the media so that a sufficiently wide portion of the media is illuminated to be imaged onto the sensor. A wider uniformly illuminated band requires more light to maintain the same illumination intensity requirement for the same throughput speed goal. For this reason, one goal in design of such optical imaging modules is maximum efficiency of illumination. That is, it is desirable to illuminate a portion of a media sheet to be imaged with sufficient intensity and uniformity to generate sufficient signal strength for the desired throughput speed by the imaging optics and sensor electronics to allow capturing an image of higher visual quality. The strength of the signal must be sufficient that the signal to noise ratio matches the desirable quantification scale of the physical reflectance from the media sheet. Equally, the illumination must be stable and uniform, both temporally and spatially over the sensor lines of all the desired channels. Lacking such stability, variation in illumination may result in imaging artifacts.

To achieve sufficient illumination intensity and stability for optical imaging modules, particularly in high end imaging devices, a variety of light sources have been utilized. As one example, high performance diffuse light sources such as external electrode Xenon fluorescent lamps are popular for their properties of high light output, instant-on features, and relative resistance to fluctuations in ambient temperature. However, a known disadvantage of high performance light sources such as Xenon fluorescent lamps is lack of efficiency in comparison to other fluorescent lamps. In particular, Xenon fluorescent lamps generate comparatively more heat relative to their light output in comparison to other fluorescent lamps, and may create thermal stress if proper cooling mechanisms are not provided. Such thermal stress may undesirably influence imaging optics, resulting in unacceptable image quality. On the other hand, particularly when larger Xenon fluorescent lamps or multiple Xenon fluorescent lamps are utilized, the need for auxiliary cooling mechanisms such as dedicated fans increases the space required to accommodate optical imaging modules incorporating such lamps, increasing also the size and cost of the electrophotographic device incorporating the optical imaging module.

Thus, it is desirable to include high performance light sources such as Xenon fluorescent lamps in optical imaging modules for electrophotographic devices for their advantageous properties as described above. However, there remains a need in the art for methods of illuminating media sheets or portions of media sheets using such high performance light sources while minimizing the disadvantages described.

### SUMMARY OF THE INVENTION

The above-mentioned and other problems are solved by applying the principles and teachings associated with the presently described method for efficiently and uniformly illuminating a scan line position and optical imaging module for implementing the method. In particular, the presently described method and optical imaging module allow use of a single high performance light source such as a Xenon fluorescent lamp, providing intense, uniform illumination of the scan line position without incurring undue thermal stress or requiring multiple lamps to achieve uniform illumination of the scan line position for relatively higher imaging throughput. Even more, by use of the present method and optical imaging module for implementing the method, uniform illumination of a scan line position may be achieved using a smaller, lower light-output light source which requires less electrical power to operate and which outputs less heat, requiring lesser auxiliary cooling than would be necessary for a larger light source.

In one aspect, a method is provided for uniformly illuminating a predetermined scan line position on a media sheet containing an image to be scanned. First, an optical path is defined between a media sheet and a sensor for receiving and converting a light image derived from that media sheet to an electrical signal. Next is selecting a predetermined scan line position which is substantially aligned with that optical path. The present method then contemplates emitting a light beam from a light source, whereby a portion of the light beam illuminates a first portion of the predetermined scan line and a portion of the light beam is reflected from a reflector to illuminate a second, opposed portion of the predetermined scan line position. In this fashion, substantially an entirety of at least the predetermined scan line position is uniformly and stably illuminated.

In another aspect there is provided a method for imaging a scan line on a media sheet. That method contemplates defining an optical path between a media sheet and a sensor for receiving and converting a light image derived from that media sheet to an electrical signal, followed by selecting a predetermined scan line position which is substantially aligned with that optical path. Then, a light beam is emitted from a high performance diffusing light source whereby a portion of the light beam illuminates a first portion of the predetermined scan line. A portion of that light beam is reflected from a reflector to illuminate a second, opposed portion of the predetermined scan line position, thereby uniformly illuminating substantially an entirety of the predetermined scan line position. At least a portion of the light beam reflected from or transmitted through the media sheet is collected by the sensor via a lens and folding mirrors, to image the portion of the media sheet defined by the predetermined scan line position.

In still yet another aspect, an optical imaging module is provided for uniformly illuminating a predetermined scan line position of a media sheet. The module includes a diffusing light source and a light reflector for illuminating at least a predetermined scan line position on a media sheet to be imaged, and also a sensor array which receives a light image derived from the media sheet via a lens and folding mirrors and converts the light image to an electrical signal. Spatially, the diffusing light source and light reflector are arrayed on opposed sides of an optical path defined between the scan line position and the sensor array, to uniformly distribute a light beam about at least the predetermined scan line position. Electrophotographic devices such as printers, scanners, copiers, and the like incorporating this optical imaging module are contemplated also.

These and other embodiments, aspects, advantages, and features of the present invention will be set forth in the description which follows, and in part will become apparent to those of ordinary skill in the art by reference to the following description of the present method and device and referenced drawings, or by practice of the invention. The aspects, advantages, and features described herein are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 schematically depicts a typical optical imaging module for imaging a media sheet;

FIG. 2 graphically depicts an illumination profile achieved by illuminating a scan line position using a single light source positioned laterally in relation to the scan line position;

FIG. 3 schematically depicts an optical imaging module according to the present description for uniformly illuminating and imaging a scan line position on a media sheet;

FIG. 4 graphically depicts an illumination profile achieved by illuminating a scan line position using an optical imaging module according to the present method; and

FIG. 5 shows an electrophotographic device, specifically a multi-function printer, including the optical imaging module of FIG. 4.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, software, and/or other changes may be made without departing from the scope of the present invention.

As described above, use of high performance light sources such as Xenon fluorescent lamps provides a number of advantages, including high intensity, instant-on illumination. For this reason, such high performance light sources are considered desirable for use in optical imaging modules for electrophotographic devices such as scanners, printers, copiers, and the like. On the other hand, such high performance light sources may create undue thermal stress, negatively influencing optical imaging and creating imaging artifacts. By the present method and devices for practicing the method, it is made possible to utilize a single, smaller light-output light source which creates less thermal stress on an optical imaging system.

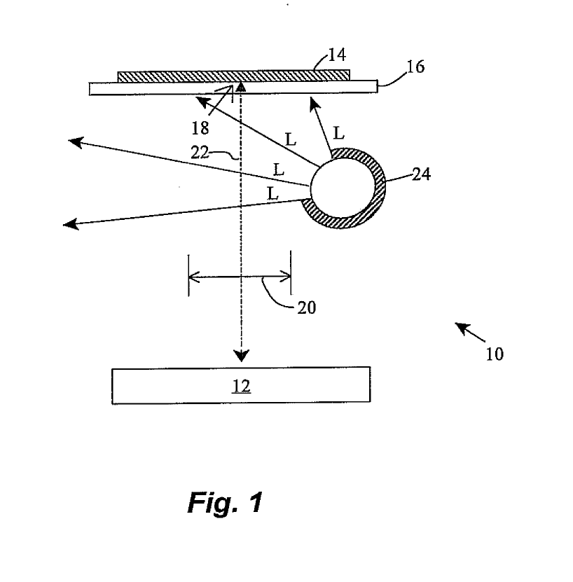

In considering use of a single light source for an optical imaging process and devices for conducting such optical imaging in an electrophotographic device, it is necessary to maintain a consistent, uniform illumination. As is well known in the art, during optical imaging of a media sheet a typical optical imaging system such as a scanner or copier essentially divides an image into a plurality of scan lines during the scanning process, with the totality of the scan lines combining to create the entirety of the image to be scanned or copied. A typical optical imaging module 10, shown in FIG. 1, includes a sensor array 12 comprising one or more photoreceptors (not shown) capable of receiving a light image and converting that image to an electrical signal which may be further processed or transmitted to a remote device. The embodiment of the optical imaging module 10 represented in FIG. 1 is a charge-coupled device, wherein an image is received by the sensor 12 by reflective transmission. However, it will be appreciated that alternative imaging modules are contemplated, such as contact image sensors, complementary metal oxide semiconductor sensors array, and the like. Other optical components such a lens and folding mirrors are typically provided, but are not shown here for convenience.

In use, a media sheet 14, such as a document containing an image for scanning or copying, is placed on a contact glass 16, with the portion of the media sheet 14 to be imaged facing the sensor array 12. Such media sheets 14 may include without limitation paper, photographic paper, transparencies, and the like. During imaging, such as a scanning or copying operation, the image is divided into a plurality of scan lines, each defined as a scan line position 18 is on the media sheet 14. The sensor array 12 photoreceptors view the scan line position 18, typically through a slit 20 of a predetermined width via a lens and folding mirrors (not shown). Providing such a slit 20 allows the sensor array 12 to restrict the light image received to substantially the light reflected from the scan line position 18 on the media sheet 14. In this fashion, flare is prevented or minimized. At the same time, the slit 20 must be sufficiently large to allow the optical imaging module 10 to maintain alignment with the scan line position 18 even under thermal or mechanical stress, increasing the challenge involved in illuminating an image. A typical slit width dimension used in the art is 5 mm, although the skilled artisan will readily appreciate that the optimal slit width will be determined by the dimensions of the optical imaging module 10 and the dimension of the sensor array 12, and can be determined by experimentation and computation.

In an optical imaging module 10 as shown in FIG. 1, typically an optical path 22 is defined, with the scan line position 18 being substantially vertically aligned with the slit 20 and the sensor array 12. It is necessary to illuminate the scan line position 18, to allow the sensor array 12 photoreceptors to properly view the portion of the image contained in that scan line position 18. Desirably, a single high performance light source 24 would be used which, while providing a desirably uniform and intense illumination of the scan line position 18, would not create undue thermal stress.

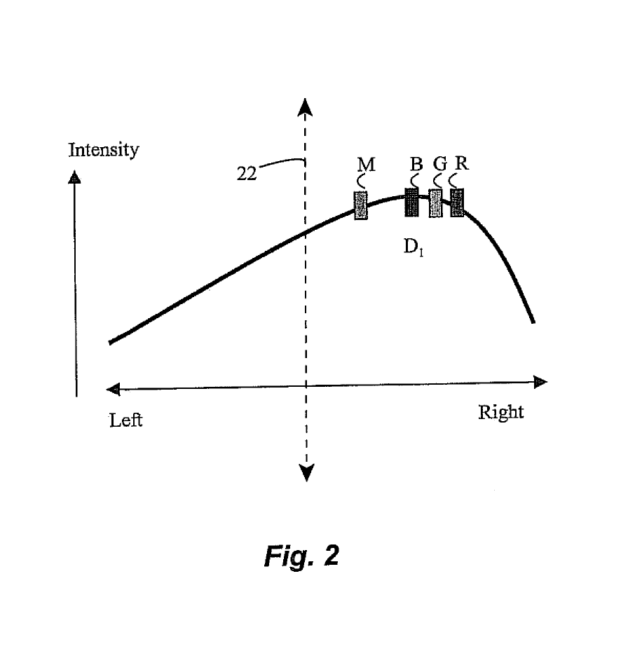

However, in a typical optical imaging module 10, it is necessary to position a light source at a distance from a media sheet 14 being imaged to provide a desired degree of illumination of a scan line being imaged. The most efficient position for a single light source 24 to uniformly illuminate the scan line would be directly aligned with the scan line position 18, but this would occlude the optical path 22. Thus, using a single light source 24, the light source must be positioned laterally of the scan line position 18, either left or right thereof (see FIG. 1). Unfortunately, unless a very intense light source 24 with a relatively larger diameter is used, a non-uniform illumination pattern of scan line position 18 is provided. This is graphically depicted in FIG. 2, showing a distribution of light, in particular in the red R, green G, blue B, and monochromatic M ranges, when a single light source 24 is positioned laterally to the right of a scan line position 18. In this configuration, the distribution of light is skewed to the right, such as at position A relative to optical path 22, and can therefore be unstable when there is instability of optical alignment in relation to the optical path 22. This would create imaging artifacts during the imaging process.

This problem could be addressed by including a second light source (not shown), also positioned laterally of the optical path 22 and scan line position 18, to provide a more uniform distribution of light about the scan line position 18. However, this solution, while potentially effective for its intended purpose, would at the least increase the costs involved. Even more, as described above, including a second light source, particularly a high performance lamp, would increase thermal stress and concomitant imaging artifacts, requiring inclusion also of additional cooling mechanisms and still more cost.

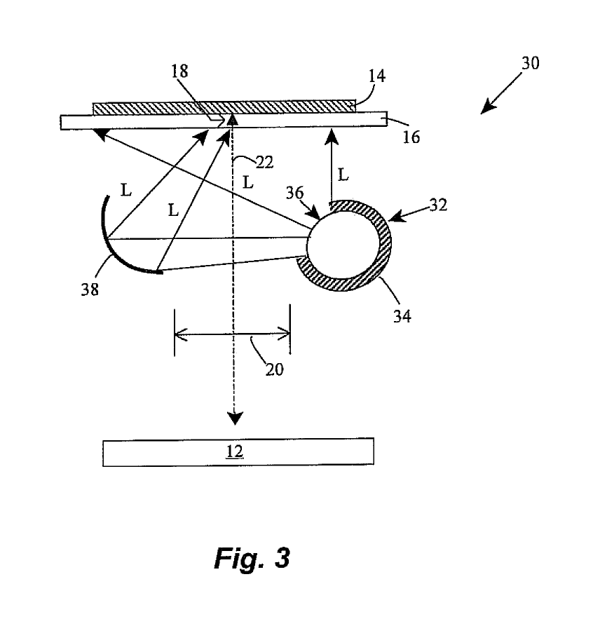

To avoid these undesirable effects, there is provided an optical imaging module 30, shown in FIG. 3, which does not require multiple light sources to achieve uniform, stable illumination of a media sheet 14 scan line position 18. As described above, the optical imaging module 30 includes a sensor array 12, with an optical path 22 defined between the scan line position 18 and the sensor array 12 via a slit 20. Typically, scan line position 18 is substantially aligned with sensor array 12 via optical path 22 and other optical components during an imaging operation. A light source 32 is provided, positioned laterally of scan line position 18 and optical path 22. Thus, a light beam L emitted from light source 32 will illuminate at least a first portion of the scan line position 18, adjacent to the positioning of light source 32.

Any suitable light source 32 providing a light beam L of suitable intensity is contemplated for use in the optical imaging module 30, including without limitation a mercury fluorescent lamp, a Xenon fluorescent lamp, a linear tungsten halogen lamp, a lightpipe, a LED array, and the like. In the embodiment depicted in FIG. 3, use of a high performance diffuse light source 32 such as a Xenon fluorescent lamp is contemplated for its intense and stable emission of light, as well as its instant-on feature. As is well known in the art, a Xenon fluorescent lamp light source 32 is a substantially cylindrical structure having a phosphorus shroud 34 with a gap 36 through which light is emitted. Upon excitation of the phosphorus shroud 34 by an external electrode via Xenon gas emission, a diffuse light beam L exits through gap 36 as shown in FIG. 3.

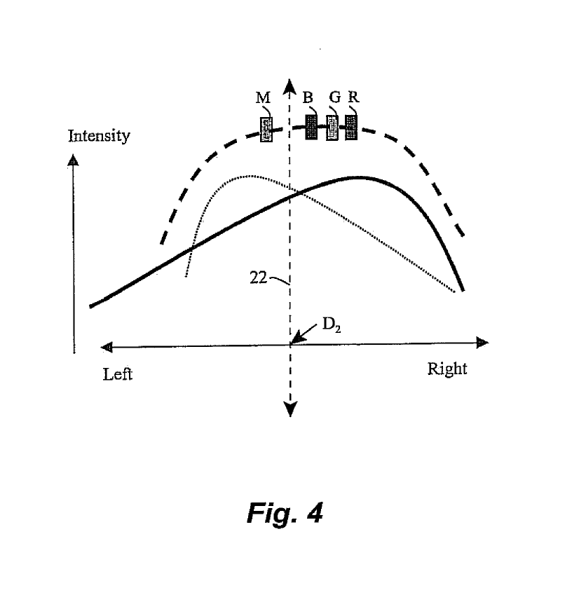

A reflector 38 is provided also, positioned laterally of scan line position 18 and optical path 22 on a side opposed to the positioning of light source 32. The reflector 38 is positioned whereby a light beam L emitted from light source 32 is reflected to illuminate at least a second portion of the scan line position 18 that is opposed to the first portion illuminated by light source 32. In this fashion, substantially the entirety of the scan line position 18 is uniformly and stably illuminated without need for more than one light source 32 or a relatively larger lamp. With reference to FIG. 4, by use of the optical imaging module 30 described herein, it has been shown that the pattern of light distribution is altered to provide a more uniform distribution about the optical path 22. That is, the desired color range distribution of light in the red R, green G, blue B, and monochromatic M ranges is properly balanced and uniform in relation to the optical path 22, such as at position D₂ wherein the depicted color range is evenly distributed about the optical path 22, reducing or eliminating potential imaging artifacts during the imaging process. Even more, because of the redistribution of the light beam L by reflector 38, use of a smaller light source 32 emitting less heat is made possible, without negatively impacting the desired level of illumination of scan line position 18. This strongly contrasts with the light distribution patterns exhibited by using a light source positioned laterally of the optical path 22 (solid line, see also FIG. 2) or by using only a reflector 38 and a remotely positioned light source (dotted line). The latter is typical of prior art illumination systems and often requires a relatively larger lamp for the same imaging throughput speed. As shown in FIG. 4, the peaks of the two portions of illumination are substantially separated in order to achieve the efficiency and uniformity. In one embodiment, each of the two portions provides substantially illumination for different scan modes such as the color mode and the monochromatic mode.

In use, the optical imaging module 30 illuminates and images an entirety of an image on a media sheet 14 by sequentially illuminating and imaging a plurality of scan line positions 18, that is, performing the steps of defining an optical path 22, selecting a scan line position 18, uniformly and stably illuminating that scan line position 18 using light source 32 and reflector 34, imaging that scan line position 18 using sensor array 12, and repeating the process until a desired portion of the media sheet 14 is imaged. This may be accomplished by translating the optical imaging module 30 along a length dimension of the media sheet 14, or alternatively by translating a length dimension of the media sheet 14 across the optical path 22 for imaging by sensor array 12. The optical imaging module 30 may be configured for incorporation into any desired electrophotographic device, including without limitation a printer, a copier, a scanner, and the like.

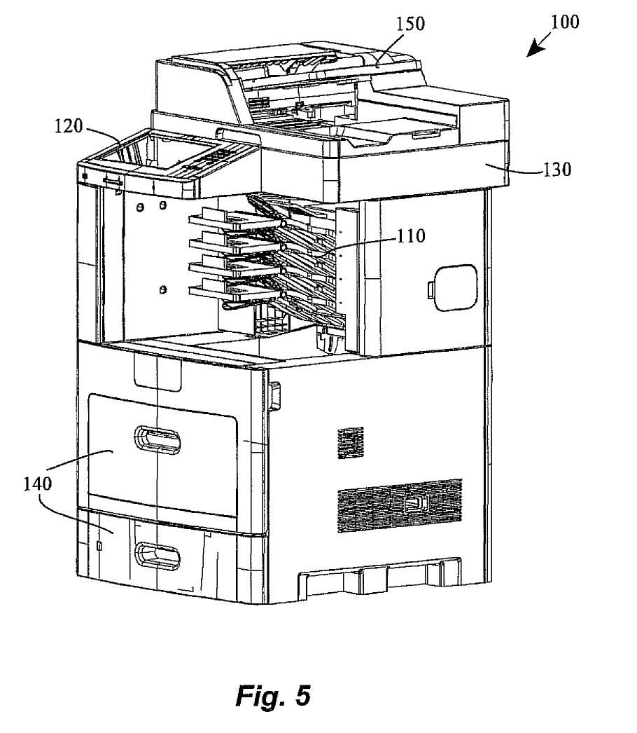

Accordingly, a method for uniformly illuminating a scan line position 18 on a media sheet 14, and optical imaging modules 30 and electrophotographic devices incorporating those modules 30, are described herein. A representative example of such an electrophotographic device 100 for transferring an image to at least one media sheet is provided, in the example shown being an all-in-one multi-function printer, is presented in FIG. 5. That device 100 is typically adapted to receive therein at least one media output option 110 for receiving an imaged media sheet, including without limitation options 110 such as a mailbox sorter, an offset media stacker, and the like. In the depicted embodiment of the device 100, the media output option 110 is installed in the device 100 without increasing a footprint and/or external dimension of the device.

The electrophotographic device 100 includes also other features well-known in the art, such as a control panel 120 for receiving input instructions from a user, a scanning unit 130 for imaging a media sheet containing text and/or design images, and at least one media tray 140 for holding one or more media sheets onto which the text and/or images are to be copied. Such media sheets may include without limitation paper, photographic paper, transparencies, and the like. A top-mounted media sheet feeder 150 is also provided in the depicted embodiment. By use of the method and optical imaging module described herein, a stable, intense, uniform illumination of a scan line 18 is provided during high speed operation of the electrophotographic device 100, without increasing thermal stress on the imaging system.

One of ordinary skill in the art will recognize that additional embodiments of the invention are also possible without departing from the teachings herein. This detailed description, and particularly the specific details of the exemplary embodiments, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures.

1. A method for uniformly illuminating a predetermined scan line position on a media sheet, comprising:
defining an optical path from a media sheet to a sensor for receiving and converting a light image derived from that media sheet to an electrical signal;
selecting a predetermined scan line position which is substantially aligned with the optical path;
emitting a light beam from a light source whereby a portion of the light beam illuminates a first portion of the predetermined scan line and a portion of the light beam is reflected from a reflector to illuminate a second, opposed portion of the predetermined scan line position, thereby uniformly illuminating substantially an entirety of at least the predetermined scan line position.

2. The method of claim 1, further including collecting at least a portion of the light beam reflected from or transmitted through the media sheet in the sensor to image the portion of the media sheet defined by the predetermined scan line position.

3. The method of claim 2, including repeating the steps of defining an optical path, selecting a predetermined scan line position, emitting a light beam to illuminate the predetermined scan line position, and collecting at least a portion of the light beam in the sensor until a predetermined portion of the media sheet image has been imaged.

4. The method of claim 1, including emitting the light beam from a diffusing light source selected from the group consisting of a mercury fluorescent lamp, a Xenon fluorescent lamp, a linear tungsten halogen lamp, a lightpipe, and a LED array.

5. The method of claim 4, including emitting the light beam from a Xenon fluorescent lamp.

6. A method for imaging a scan line on a media sheet, comprising:
defining an optical path from a media sheet to a sensor for receiving and converting a light image derived from that media sheet to an electrical signal;
selecting a predetermined scan line position which is substantially aligned with the optical path;
emitting a light beam from a high performance diffusing light source whereby a portion of the light beam illuminates a first portion of the predetermined scan line and a portion of the light beam is reflected from a reflector to illuminate a second, opposed portion of the predetermined scan line position, thereby uniformly illuminating substantially an entirety of the predetermined scan line position; and
collecting at least a portion of the light beam reflected from or transmitted through the media sheet in the sensor to image the portion of the media sheet defined by the predetermined scan line position.

7. The method of claim 6, further including repeating the steps of defining an optical path, selecting a predetermined scan line position, emitting a light beam to illuminate the predetermined scan line position, and collecting at least a portion of the light beam reflected from or transmitted through the media sheet until a desired portion of the media sheet image has been imaged.

8. The method of claim 6, including emitting the light beam from a diffuse light source selected from the group consisting of a mercury fluorescent lamp, a Xenon fluorescent lamp, a linear tungsten halogen lamp, a lightpipe, and a LED array.

9. The method of claim 8, including emitting a light beam from a Xenon fluorescent lamp.

10. An optical imaging module for uniformly illuminating a predetermined scan line position of a media sheet, comprising:
a diffusing light source for emitting a light beam and a light reflector for reflecting at least a portion of that light beam, said diffusing light source and light reflector cooperating to uniformly illuminate at least a predetermined scan line position on a media sheet to be imaged; and
a sensor array for receiving a light image derived from the media sheet and for converting the light image to an electrical signal;
wherein the diffusing light source and light reflector are arrayed on opposed sides of an optical path defined between the scan line position and the sensor array, to uniformly distribute a light beam about at least the predetermined scan line position.

11. The optical imaging module of claim 10, wherein the diffusing light source is selected from the group consisting of a mercury fluorescent lamp, a Xenon fluorescent lamp, a linear tungsten halogen lamp, a lightpipe, and a LED array.

12. The optical imaging module of claim 11, wherein the diffusing light source is a Xenon fluorescent lamp.

13. The optical imaging module of claim 10, wherein the sensor is selected from the group consisting of a charge-coupled device, a complementary metal oxide semiconductor sensor array, and a photodiode array.

14. An electrophotographic device comprising the optical imaging module of claim 10.
